(19) United States
(12) Patent Application Publication
(10) Pub. No.: US 2005/0012342 A1
(43) Pub. Date: Jan. 20, 2005

(54) Attachment mechanism

(75) Inventor: Chao-Kang Li, Hsichih (TW)

Correspondence Address: QUINTERO LAW OFFICE, 1617 BROADWAY, 3RD FLOOR, SANTA MONICA, CA, 90404, US

(73) Assignee: Aopen Inc.

(21) Appl. No.: 10/684,095

(22) Filed: Oct. 10, 2003

(30) Foreign Application Priority Data
Jun. 11, 2003 (TW) 92210632

(51) Int. Cl. E05C 3/06

(52) U.S. Cl. 292/52

(57) ABSTRACT

An attachment mechanism. The attachment mechanism comprises a housing, a cover plate, a fixed member, and a pivoting member. The fixed member is disposed on the cover plate. The pivoting member is pivoted on the fixed member, having a contacting portion and a lever portion connected thereto, wherein the lever portion has a protrusion such that a part of the housing is wedged between the contacting portion and the protrusion when the cover plate is attached to the housing. The pivoting member pivots, and applies a force on the housing such that the cover plate is separated from the housing.

### BACKGROUND OF THE INVENTION

1. Field of the Invention

The present invention relates to an attachment mechanism, and in particular to an attachment mechanism connecting the cover plate and the housing of a computer.

2. Description of the Related Art

FIG. 1 is a perspective diagram of a conventional computer. As shown in FIG. 1, the computer 1 comprises a housing 2 and two cover plates 3 disposed at the lateral sides thereof. The electrical components such as main boards, CPUs, and hard disks of the computer are disposed inside the housing 2 and the cover plates 3. Generally, the conventional cover plates 3 are attached to the housing 2 by screws 31. In FIG. 1, the cover plates 3 are mounted on the lateral sides of the housing 2 by the screws 31 in the back plate 21 thereof.

To inspect or replace the components inside the computer, the cover plates 3 are detached from the housing 2. The screws 31 must first be removed to detach the cover plates 3 from the housing 2. Furthermore, a depression 30 is disposed on the cover plate 3 such that it can be manually removed.

As mentioned above, however, attaching and detaching the cover plates 3 can be inconvenient as the screws 31 must be removed with a screwdriver. Moreover, as the depression 30 is shallow, the cover plates 3 are difficult to detach manually.

To address the above-mentioned disadvantages of the conventional computer housing, the present invention provides an attachment mechanism that enables easy and rapid attachment and detachment of the cover plates 3 from the housing.

### SUMMARY OF THE INVENTION

An object of the invention is to provide an attachment mechanism connecting the cover plate and the housing of a computer. The attachment mechanism comprises a housing, a cover plate, a fixed member, and a pivoting member. The fixed member is disposed on the cover plate. The pivoting member is pivoted on the fixed member, having a contacting portion and a lever portion connected thereto, wherein the lever portion has a protrusion such that a part of the housing is wedged between the contacting portion and the protrusion when the cover plates are attached to the housing. The pivoting member pivots to exert a force on the housing such that the cover plate separates from the housing.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a perspective diagram of a conventional computer;

FIG. 2a is an exploded diagram of the attachment mechanism in accordance with the present invention;

FIG. 2b is a perspective diagram of the lock plate joined to the lock member in accordance with the present invention;

FIG. 3a is a perspective diagram of the cover plates joined to the housing in accordance with the present invention;

FIG. 3b is a top view of FIG. 3b showing the cover plates joined to the housing in accordance with the present invention;

FIG. 3c is a large view diagram of P in FIG. 3b according to the present invention;

FIG. 4a is another perspective diagram of the cover plate joined to the housing in accordance with the present invention;

FIG. 4b is a large view diagram of Q in FIG. 4a according to the present invention;

FIG. 5 is a perspective diagram of the cover plate separated from the housing in accordance with the present invention; and

FIG. 6 is a perspective diagram of the pivoting member locked on the cover plate in accordance with the present invention.

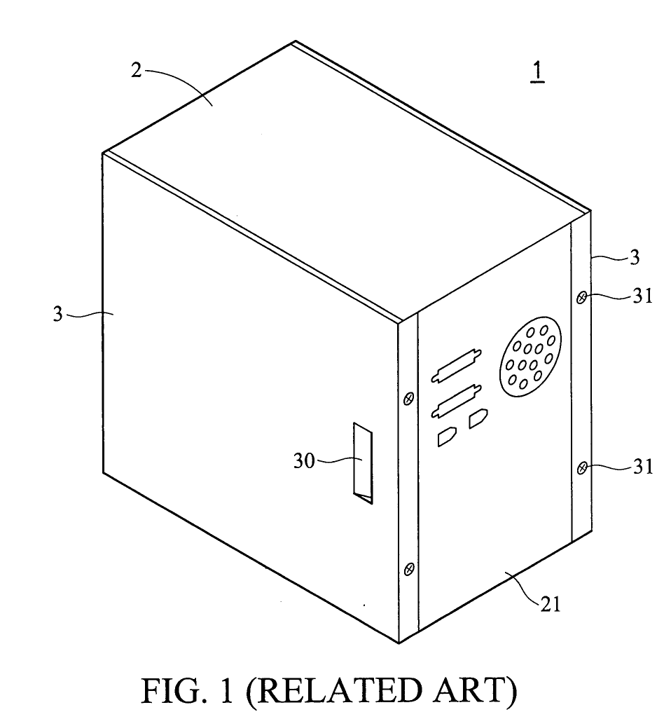

### DETAILED DESCRIPTION OF THE INVENTION

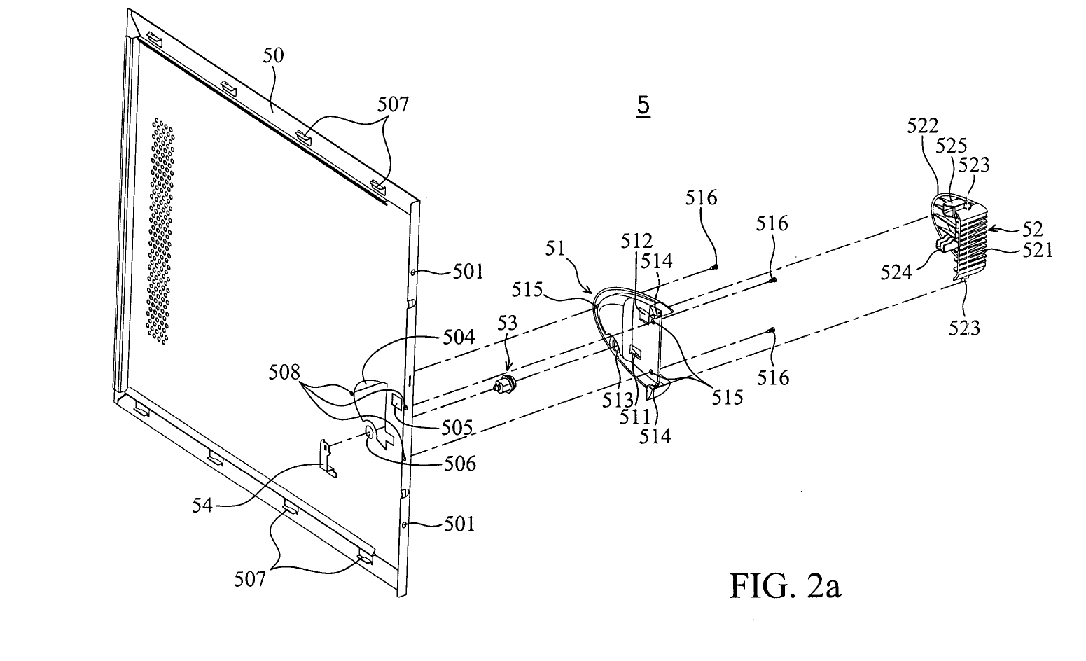

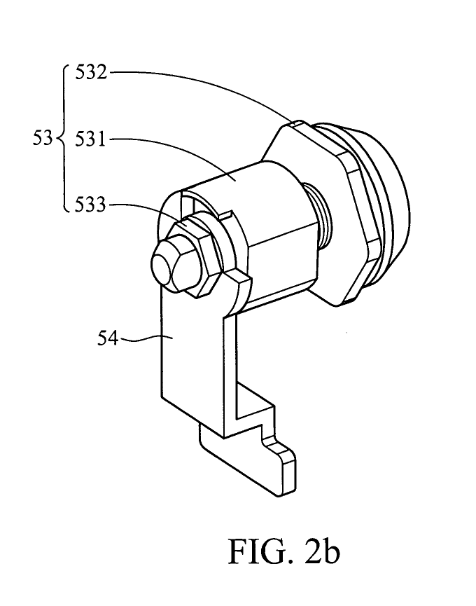

FIG. 2a is an exploded diagram of the attachment mechanism in accordance with the present invention. As shown in FIG. 2a, the attachment mechanism 5 comprises a cover plate 50, a fixed member 51, a pivoting member 52, a lock member 53, and a lock plate 54. The fixed member 51 has a first opening 511, a second opening 512, a third opening 513, a plurality of screw holes 515 and a pair of cavities 514. The cover plate 50 has a fourth opening 504, a fifth opening 505, a sixth opening 506 and a plurality of screw holes 508. The fixed member 51 is fixed to the cover plate 50 by the screws 516 through the screw holes 515 and 508. Moreover, the cover plate 50 can also be attached to the housing 6 by screws through the screw holes 501.

Furthermore, the L-shaped pivoting member 52 comprises an contacting portion 521 and a lever portion 522. As shown in FIG. 2a, the contacting portion 521 has a pair of protruding pivots 523 rotatably joined in the cavities 514 such that the pivoting member 52 may be pivoted on the pivot 523 with respect to the fixed member 51.

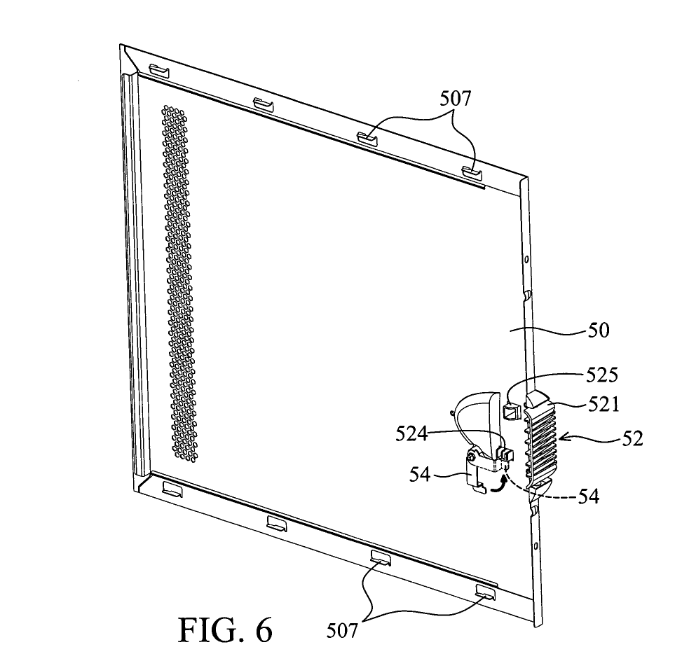

The lever portion 522 has a joining portion 524 and a protrusion 525 as shown in FIG. 2a. Referring to FIGS. 2a and FIG. 6, the joining portion 524 and the protrusion 525 protrude from the inner side of the lever portion 522 and can pass through the cover plate 50. When the cover plate 50 is attached to the housing 6, the joining portion 524 and the protrusion 525 respectively pass through the first opening 511 and the second opening 512 of the fixed member 51 and the fourth opening 504 and the fifth opening 505 of the cover plate 50.

Particularly, the attachment mechanism 5 further comprises a lock member 53 and a lock plate 54. As shown in FIGS. 2a and FIG. 2b, the lock member 53 comprises a lock body 531, a first nut 532 and a second nut 533. The lock member 53 passes through the third opening 513 of the fixed member 21 and the sixth opening 506 of the cover plate 50 sequentially. The lock member 53 is fixed to the cover plate 50 by the first nut 532 clipping the cover plate 50, and the lock plate 54 is fixed to the lock body 531 by the second nut 533 clipping the lock plate 54. Thus, the lock member 53 pivots to join the lock plate 54 and the pivoting member 52 such that the cover plate 50 is attached to the housing 6. Accordingly the present invention provides a safe, convenient, and highly stable method of attaching the cover plate 50 to the housing 6.

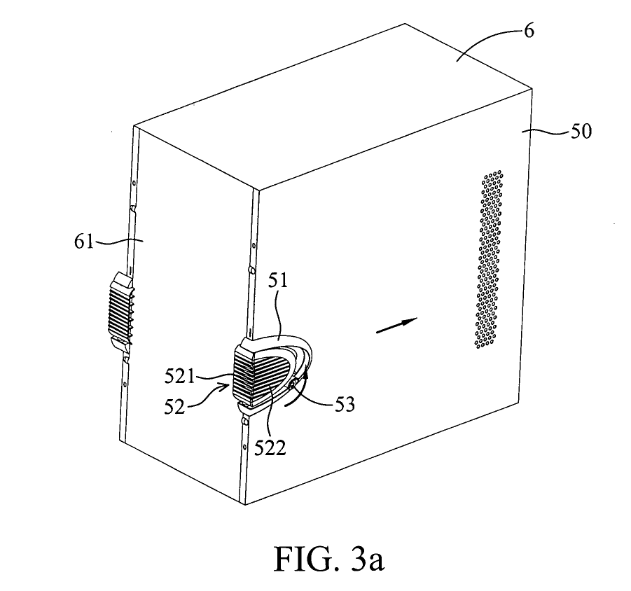

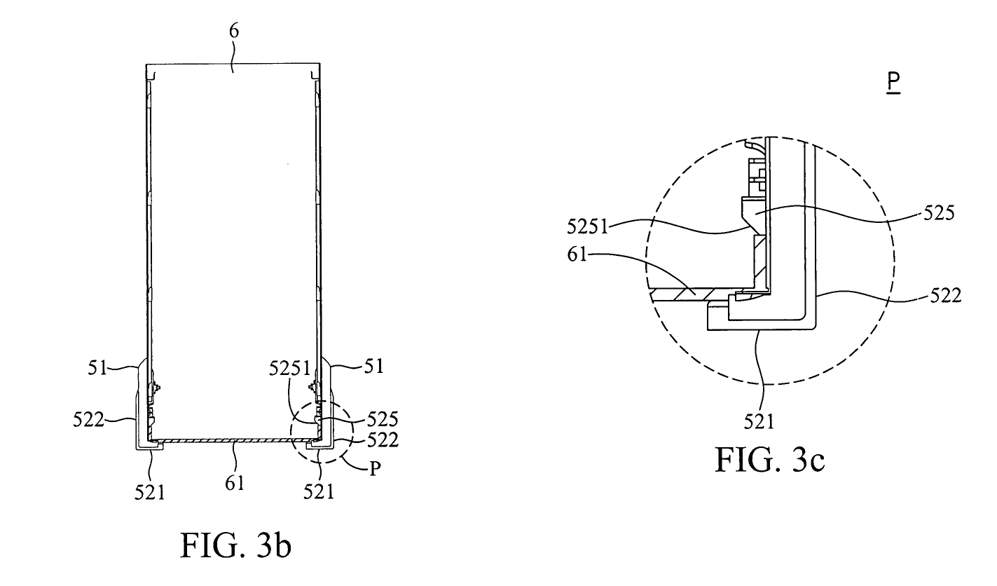

FIG. 3a is a perspective diagram of the cover plates 50 joined to the housing 6 in accordance with the present invention. The cover plate 50 is attached to a side of the housing 6 by pulling the lever portion 522 parallel to the cover plate 50 as indicated by the arrow in FIG. 3a.

As shown in FIGS. 3b and FIG. 3c, when the cover plate 50 is joined to the housing 6, the lateral part of the back plate 61 of the housing 6 is between the contacting portion 521 and the protrusion 525 of the pivoting member 52. To attach the cover plate 50 to the housing 6, the pivoting member 52 pivots such that the protrusion 525 passes through the second opening 512 and the lateral part of the back plate 61 slides along the slanted surface 5251 of the protrusion 525. Furthermore, when the pivoting member 52 pivots, the back plate 61 is guided along the slanted surface 5251 causing the cover plate 50 to move forward as indicated by the arrow in FIG. 3a. Subsequently, as the contacting portion 521 abuts the back plate 61 of the housing 6, the lateral part of the back plate 61 is then wedged and fixed between the contacting portion 521 and the protrusion 525 of the pivoting member 52 such that the cover plate 50 is securely attached to the housing 6.

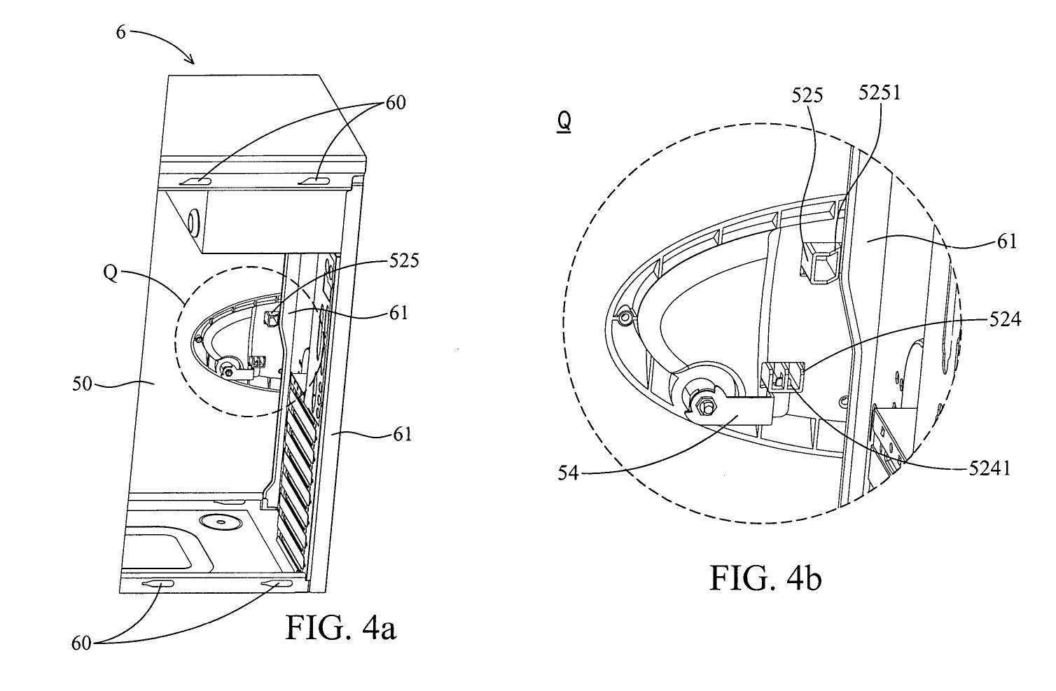

FIG. 4a is another perspective diagram of the cover plate 50 joined to the housing 6 according to the present invention and FIG. 4b is a large view diagram of B in FIG. 4a. As shown in FIG. 4a, the housing 6 has several openings 60 which the protrusions 507 of the cover plate 50 pass through to securely attach the cover plates 50 to the housing 6. In FIG. 4b, the pivoting member 52 pivots such that the lateral part of the back plate 61 is guided along the slanted surface 5251 and wedged between the contacting portion 521 and the protrusion 525 of the pivoting member 52. As the pivoting member 52 is restricted by the lock plate 54, the cover plate 50 and the housing 6 are securely attached.

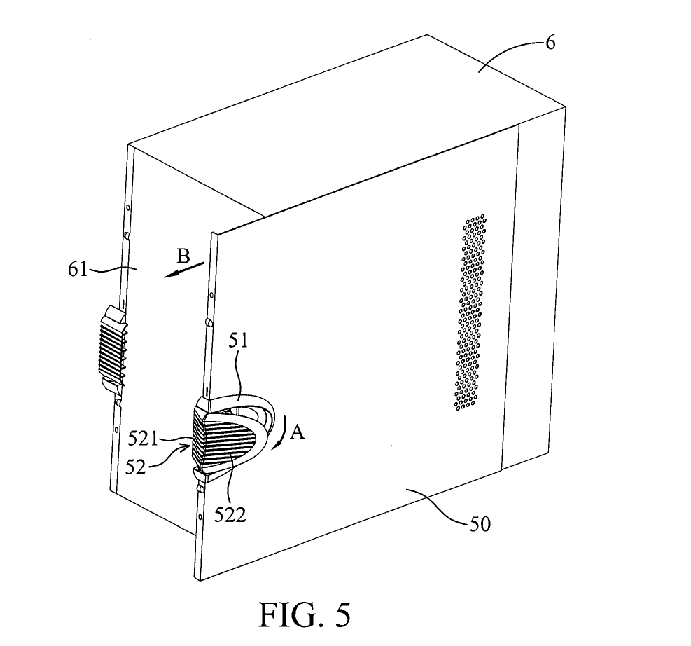

FIG. 5 is a perspective diagram of the cover plate 50 separated from the housing 6 according to the present invention, wherein the fixed member 51 is fixed to the cover plate 50. When detaching the cover plate 50 from the housing 6, the pivoting portion 52 is pulled in direction A such that the back plate 61 departs from the position between the contacting portion 521 and the protrusion 525. Moreover, as the contacting portion 521 abuts the back plate 61, a reaction force is exerted thereto due to the rotation of the rotating portion 52 such that the cover plate 50 moves backward and separates from the housing 6 in direction B as shown in FIG. 5. Particularly, the lever portion 522 of the rotating 52 member in this embodiment is longer than the contacting portion 521 such that the cover plate 50 is easily detached by leverage.

FIG. 6 is a perspective diagram of the pivoting member 52 locked on the cover plate 50 according to the present invention. Referring to FIGS. 2b, 4b and FIG. 6, the lock plate 54 is on the inner side of the cover plate 50 and fixed to the lock member 53 by the second nut 533. Moreover, the lock plate 54 connected to the lock member 53 is rotatably driven by a key and can be joined to the pivoting member 52. The pivoting member 52 is restricted when the lock plate 54 joined to the joining portion 524. As shown in FIG. 6, the broken lines illustrate the lock plate 54 rotating to the slot 5241 of the joining portion 524 (as shown in FIG. 4b) to lock and restrict the pivoting member 52 preventing further movement. The lock member 53 enables easy attachment of the cover plate 50 to the housing 6 with the key.

In summary, the attachment mechanism of the present invention does not require screws, thus reducing the time and labor expended when attaching or detaching the cover plate 50 to the housing 6. Moreover, the lever portion 522 of the pivoting member 52 is longer than the contacting portion 521 such that the cover plate 50 is easily attached and detached from the housing 6 by leverage.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. An attachment mechanism, comprising:
a housing;
a cover plate;
a fixed member disposed on the cover plate;
a pivoting member pivoted on the fixed member, having a contacting portion and a lever portion connected thereto, wherein the lever portion has a protrusion such that a part of the housing is wedged between the contacting portion and the protrusion when the cover plate is attached to the housing, and the pivoting member pivots and applies a force on the housing such that the cover plate is separated from the housing.

2. The attachment mechanism as claimed in claim 1, wherein the lever portion is parallel to the cover plate when the cover plate and the housing are joined.

3. The attachment mechanism as claimed in claim 1, wherein the pivoting member is L-shaped.

4. The attachment mechanism as claimed in claim 1, wherein the protrusion has a slanted surface.

5. The attachment mechanism as claimed in claim 1, wherein the fixed member has at least an opening which the protrusion passes through.

6. The attachment mechanism as claimed in claim 1, wherein the cover plate has at least an opening which the protrusion passes through.

7. The attachment mechanism as claimed in claim 1, wherein the pivoting member further has a joining portion protruding from the lever portion.

8. The attachment mechanism as claimed in claim 1, wherein the cover plate has at least an opening which the joining portion passes through.

9. The attachment mechanism as claimed in claim 8, wherein the fixed member has at least an opening which the joining portion passes through.

10. An attachment mechanism, comprising:
a housing;
a cover plate;
a fixed member disposed on the cover plate;
a lock plate;
a lock member, passing through the cover plate and connecting the lock plate;
a pivoting member pivoted on the fixed member, having a contacting portion and a lever portion connected thereto, wherein the lever portion has a protrusion such that a part of the housing is wedged between the contacting portion and the protrusion when the cover plate is attached to the housing, and the pivoting member pivots and applies a force on the housing such that the cover plate is separated from the housing.

11. The attachment mechanism as claimed in claim 10, wherein the pivoting member further has a slot and the lock plate is located therein to restrict the pivoting member.

12. The attachment mechanism as claimed in claim 11, wherein the pivoting member further has a joining portion protruding from the lever portion, and the slot is disposed in the joining portion.
